(19) United States
(12) Patent Application Publication
(10) Pub. No.: US 2007/0291484 A1
(43) Pub. Date: Dec. 20, 2007

(54) ILLUMINATION SYSTEM AND PROJECTION APPARATUS

(75) Inventors: Sung-Nan Chen, Hsinchu (TW); Keng-Han Chuang, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 11/736,890

(22) Filed: Apr. 18, 2007

(30) Foreign Application Priority Data
Jun. 14, 2006 (TW) 95121190

(51) Int. Cl. F21V 5/04

(52) U.S. Cl. 362/230; 362/235

(57) ABSTRACT

An illumination system includes a point light source array, a lens and a collimating lens. The collimating lens is disposed between the point light source array and the lens. The point light source array is suitable for emitting a planar light source and both the lens and the collimating lens are disposed on the optical path of the planar light source. Besides, the lens has two different focal lengths in a first axis and a second axis. The present invention further provides a projection apparatus employing the illumination system.

### CROSS-REFERENCE TO RELATED APPLICATION

This application claims the priority benefit of Taiwan application serial no. 95121190, filed Jun. 14, 2006. All disclosure of the Taiwan application is incorporated herein by reference.

### BACKGROUND OF THE INVENTION

1. Field of Invention

The present invention relates to a display apparatus, and more particularly, to a projection apparatus and an illumination system therein.

2. Description of the Related Art

In recent years, there is a more and more prevailing tendency in the projector field to employ a light emitting diode (LED) or a laser device as the light source. However, a single LED or laser device used as the light source in a projector does not exhibit satisfactory image brightness. Therefore instead, it usually employs light emitting diodes (LEDs) or laser devices arranged in an array to serve as the light source to advance image brightness.

FIG. 1A is a diagram of a conventional illumination system, while FIG. 1B is the angle distribution diagram of the received light on the sectioning plane along line I-I′ in FIG. 1A. Referring to FIG. 1A, a conventional illumination system 100 includes an LED array 110 and a circularly symmetrical collimating lens 120. The LED array 110 is a 2×4 LED array with different length and width and is suitable for providing a planar light source 112, while the circularly symmetrical collimating lens 120 is used for converging the planar light source 112 emitted by the LED array 110.

Due to the different length and width of the LED array 110, after the planar light source 112 emitted by the LED array 110 passes the circularly symmetrical collimating lens 120 and gets converged, light emitted by each of the LEDs has different convergent result according to the different off-axis extent thereof, which results in unperfected parallelism and pretty much light energy loss. It is noted from the angle distribution diagram of the received light in FIG. 1B that after the planar light source 112 provided by the LED array 110 passes the circularly symmetrical collimating lens 120 and gets converged, the major light intensity is distributed within ±3 degree angles in the X axis, while the major light intensity is distributed within ±5.5 degree angles in the Y axis. Therefore, the light intensity distributions of the planar light source are quite unsymmetrical in the X axis and in the Y axis, which makes a planar light source 112 with a large lighting area hard to give out a parallel light beam. On the other hand, the ideal light intensity distribution curve of a planar light source should have a circle-like profile, but the distribution curve of the planar light source 112 provided by the conventional illumination system does not, or rather has a rectangular-like profile, which affects the imaging quality of the projection apparatus quite badly.

### SUMMARY OF THE INVENTION

An objective of the present invention is to provide an illumination system where lenses are disposed to improve the symmetry of distributions in the X axis and in the Y axis of light intensity vs. included angle between light ray and the optical axis of the planar light source emitted by a point light source array with an aspect ratio unequal to one, so as to further increase the collimating extent of the illumination system.

Another objective of the present invention is to provide a projection apparatus to advance optical utilization efficiency.

Other objectives, features and advantages of the present invention will be further understood from the further technology features disclosed by the present invention wherein there is shown and described a preferred embodiment of this invention, simply by way of illustration of one of the modes best suited to carry out the invention.

To achieve one, some or all of the above-mentioned objectives or other objectives, one of the embodiments of the present invention provides an illumination system, which includes a point light source array, a lens and a collimating lens. The collimating lens is disposed between the point light source array and the lens. The point light source array is suitable for emitting a planar light source and both the lens and the collimating lens are disposed on the optical path of the planar light source. In addition, the two focal lengths of the lens in a first axis and in a second axis perpendicular to the first axis are different from each other.

The present invention further provides a projection apparatus, which includes a light valve, a projection lens and the above-described illumination system. The light valve is disposed on the optical path of the planar light source emitted by the illumination system, so as to convert the planar light source into an image light source. The projection lens is disposed on the optical path of the image light source.

Since the illumination system of the present invention employs a lens with two unequal local lengths in the first axis and in the second axis, the parallelism of the planar light source is accordingly increased, which further results in an advanced optical utilization efficiency of the projection apparatus.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1A is a view of a conventional illumination system.

FIG. 1B is the angle distribution diagram of the received light i on the sectioning plane along line I-I′ in FIG. 1A.

FIG. 2 is a view of a projection apparatus according to an embodiment of the present invention.

FIG. 3 is a view of the point light source array in FIG. 2.

FIG. 4A is a view of the illumination system in FIG. 2.

FIG. 4B is the angle distribution diagram of the light on the sectioning plane along line II-II′ in FIG. 4A.

FIG. 5 is a perspective view of the lens in FIG. 2.

FIGS. 6A and 6B are perspective views of another two lenses of the present invention.

### DESCRIPTION OF THE EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

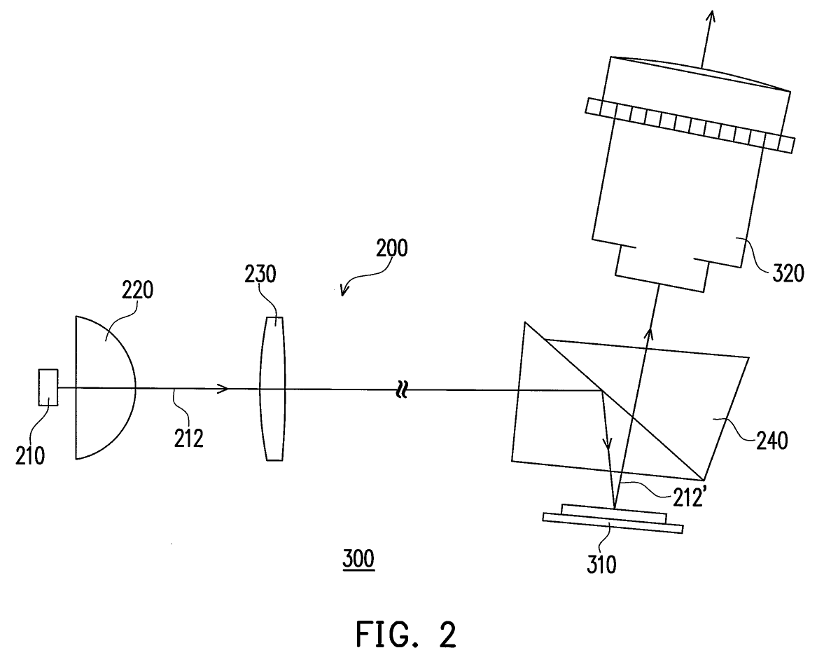

FIG. 2 is a view of a projection apparatus according to an embodiment of the present invention. Referring to FIG. 2, a projection apparatus 300 of the embodiment includes a light valve 310, a projection lens 320 and an illumination system 200. The light valve 310 is disposed between the projection lens 320 and the illumination system 200. The illumination system 200 includes a point light source array 210, a collimating lens 220 and a lens 230. The collimating lens 220 is a circularly symmetrical collimating lens and is disposed between the point light source array 210 and the lens 230. The point light source array 210 is suitable for emitting a planar light source 212, while the collimating lens 220, the lens 230 and the light valve 310 are disposed on the optical path of the planar light source 212. After the planar light source 212 passes the collimating lens 220 and the lens 230, the planar light source 212 is projected onto the light valve 310 by which the planar light source 212 is converted into an image light source 212′. The projection lens 320 is disposed on the optical path of the image light source 212′, so as to project the image light source 212′ onto a screen (not shown) and further to display images.

In the above-mentioned projection apparatus 300, the light valve 310 can be a transmissive-type light valve or a reflective-type light valve and in FIG. 2 a reflective-type light valve is given as exemplary only. The reflective-type light valve can be a digital micro-mirror device (DMD) or a liquid crystal on silicon panel (LCOS panel). Besides, a total internal reflection prism (TIR prism) 240 can be disposed in front of the light valve 310 to reflect the planar light source 212 emitted by the point light source array 210 onto the light valve 310. It will be apparent to those skilled in the art that the present invention does not limit to dispose the TIR prism 240 only.

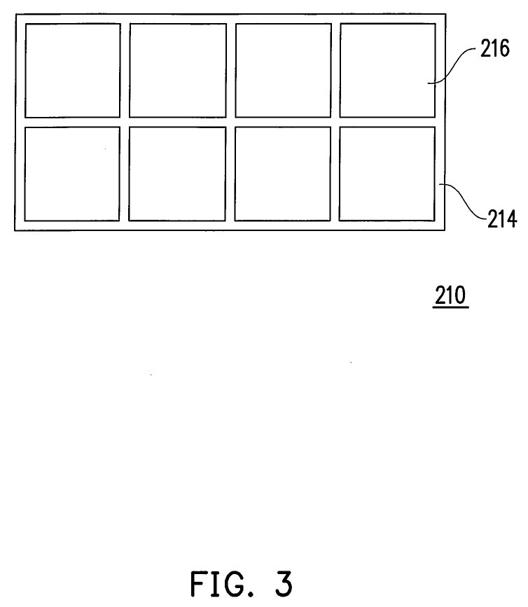

Referring to FIG. 3, the point light source array 210 includes a substrate 214 and multiple point light sources 216, which can be LEDs or laser light sources arranged in an array with different length and width on the substrate 214; that is to say a point light source array can be represented by N×M, where N≠M, and N and M are positive integers. The 2×4 array, the point light source array showing in FIG. 3, is considered as exemplary only and the present invention does not limit the quantity of the point light sources. Besides, the point light source 216 possesses at least a color. Usually, the point light source 216 can be divided into red point light source, green point light source and blue point light source, and the point light sources 216 with different colors can emit light simultaneously or asynchronously.

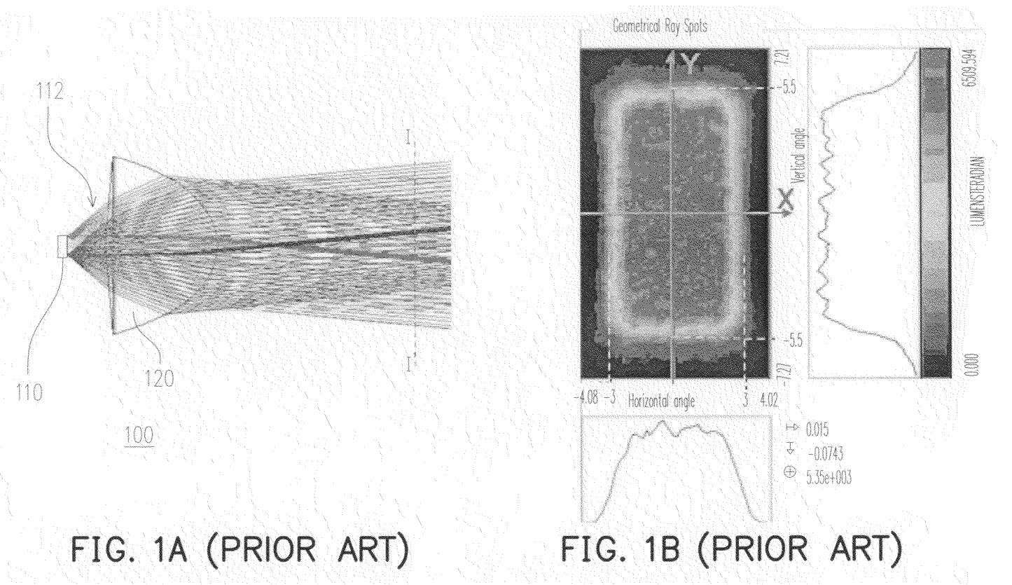

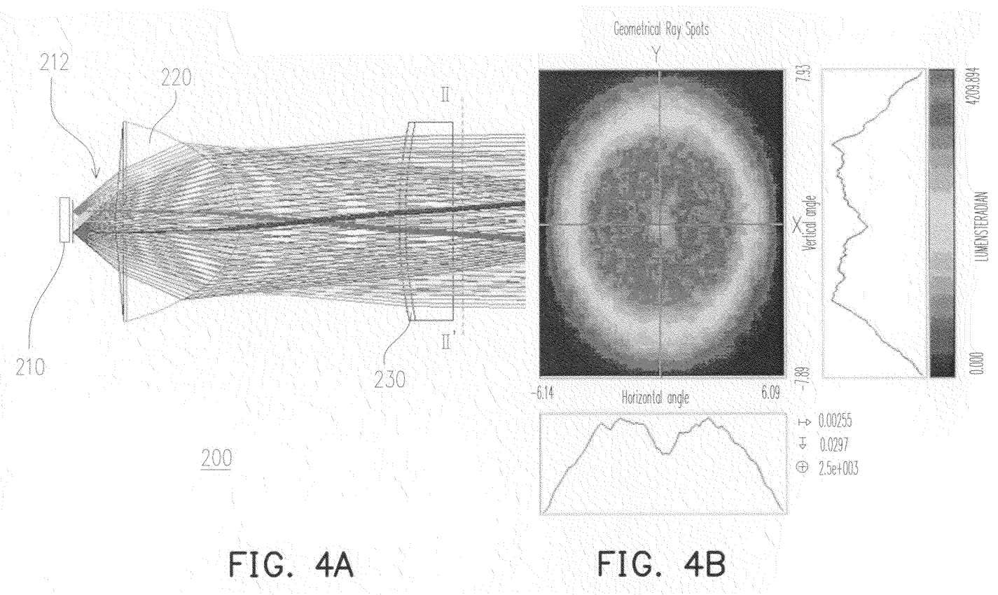

FIG. 4A is a view of the illumination system in FIG. 2, FIG. 4B is the angle distribution diagram of the light on the sectioning plane along line II-II′ in FIG. 4A and FIG. 5 is the perspective view of the lens in FIG. 2. Referring to FIGS. 4A, 4B and 5, in order to overcome the problems of the unperfected parallelism and the unsymmetricalal distributions of the light occurred with a conventional planar light source after passing the collimating lens, an extra lens 230 is disposed behind the collimating lens 220 in the embodiment. The focal lengths of the lens 230 in a first axis (the X axis shown in FIG. 5) and in a second axis (the Y axis shown in FIG. 5) perpendicular to the first axis are unequal to each other. In other words, the present embodiment increases the parallelism of the planar light source 212 and advances the distribution symmetry of the light in the X axis and in the Y axis by respectively adjusting the two focal lengths of the lens 230 in the first axis and in the second axis to appropriate values. In the embodiment, the lens 230 can be a biconic lens, which has a first surface 232 and a second surface 234 opposite to the first surface 232, the curvatures of the first surface 232 in the X axis and in the Y axis are unequal to each other and the second surface 234 is a plane. The different curvatures of the first surface 232 in the X axis and in the Y axis enable the lens 230 to have different focal lengths in the X axis and in the Y axis. In comparison with FIG. 1B, in FIG. 4B, the angle distribution of light of the planar light source 212 after the lens 230 is more symmetrical in the X axis and in the Y axis and has a profile approximating to an ideal circle. Consequently, the projection apparatus 300 of the embodiment has higher optical utilization efficiency and better imaging quality.

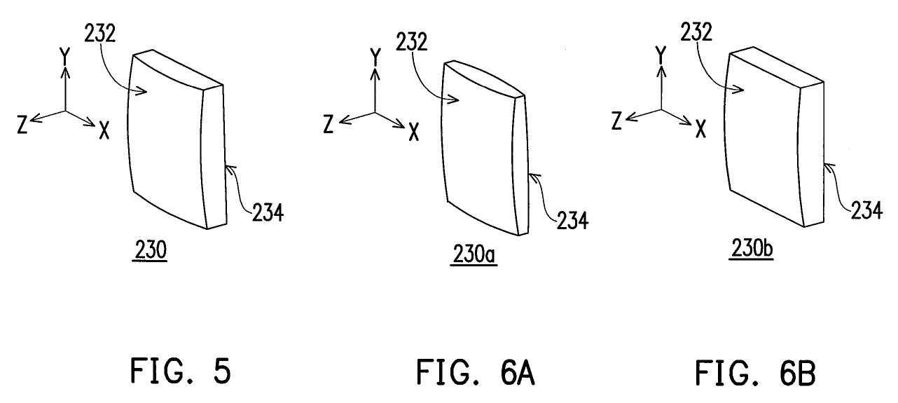

The lens 230 in the invention is not limited to the above-mentioned biconic lens shown in FIG. 5; and two more optical elements, but still not limited by the present invention, can be served as the lens, which are described hereinafter. FIGS. 6A and 6B are perspective views of another two lenses of the present invention. Referring to FIG. 6A, a lens 230a is a biconic lens too. Different from the lens 230 in FIG. 5, the curvatures of the first surface 232 of the biconic lens in the X axis and in the Y axis are unequal to each other and the curvatures of the second surface 234 in the X axis and in the Y axis are unequal to each other as well. In addition, the lens 230b shown in FIG. 6B is a cylindrical lens, and the curvature of the first surface 232 thereof in the X axis is zero, while the curvature thereof in the Y axis is not zero.

Note that the cylindrical lens used in the present invention allows the first surface 232 having a curvature of zero in the Y axis and having another curvature in the X axis which is not equal to zero. The present invention can also employ a Fresnel lens as the lens (not shown), which has different focal lengths in the X axis and in the Y axis. Those skilled in the art should be known that other optical elements, such as a fly eye lens or a light integration rod (LIR) (not shown by the figures), can be further disposed between the lens 230 and the TIR prism 240.

In summary, the projection apparatus and the illumination system thereof of the present invention have at least one or more the following advantages:

1. The lenses used in the present invention contribute to improve the parallelism of the planar light source, which further advances the optical utilization efficiency of the projection apparatus.

2. The lenses used in the present invention are able to increase the angle distribution symmetry of the light of the planar light source in the X axis and in the Y axis and make the profile of angle distribution of the light of the planar light source approximating to an ideal circle profile, which results in improved imaging quality of the projection apparatus.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising:
a point light source array, suitable for emitting a planar light source, the point light source array comprising a substrate and multiple point light sources, wherein the point light sources are arranged on the substrate in an N×M array, and N≠M, and N and M are positive integers;
a lens, disposed on the optical path of the planar light source, wherein a first surface of the lens has different local lengths in a first axis and in a second axis which is perpendicular to the first axis, and the angle distribution of light of the planar light source after passing the lens is approximately symmetrical in the X axis and in the Y axis; and
a collimating lens, disposed on the optical path of the planar light source and located between the point light source array and the lens.

2. The illumination system as recited in claim 1, wherein the lens is a biconic lens, the biconic lens has a first surface and a second surface opposite to the first surface, and the curvatures of the first surface in the first axis and in the second axis are unequal to each other and the second surface is a plane.

3. The illumination system as recited in claim 1, wherein the lens is a biconic lens, the biconic lens has a first surface and a second surface opposite to the first surface, the curvatures of the first surface in the first axis and in the second axis are unequal to each other and the curvatures of the second surface in the first axis and in the second axis are unequal to each other.

4. The illumination system as recited in claim 1, wherein the lens is a cylindrical lens and one of the curvatures of the first surface of the cylindrical lens in the first axis and in the second axis is equal to zero.

5. The illumination system as recited in claim 1, wherein the lens is a Fresnel lens.

6. The illumination system as recited in claim 1, wherein the collimating lens is a circularly symmetrical lens.

7. The illumination system as recited in claim 1, wherein the point light sources are light emitting diodes or laser light sources.

8. The illumination system as recited in claim 1, wherein the point light sources possess at least a color.

9. A projection apparatus, comprising:
an illumination system, comprising:
a point light source array, suitable for emitting a planar light source;
a lens, disposed on the optical path of the planar light source, wherein a first surface of the lens has different local lengths in a first axis and in a second axis which is perpendicular to the first axis, and the angle distribution of the light of the planar light source after passing the lens is approximately symmetrical in the X axis and in the Y axis; and
a collimating lens, disposed on the optical path of the planar light source and located between the point light source array and the lens;
a light valve, disposed on the optical path of the planar light source, so as to convert the planar light source into an image light source; and
a projection lens, disposed on the optical path of the image light source.

10. The projection apparatus as recited in claim 9, wherein the lens is a biconic lens, the biconic lens has a first surface and a second surface opposite to the first surface, the curvatures of the first surface in the first axis and in the second axis are unequal to each other and the second surface is a plane.

11. The projection apparatus as recited in claim 9, wherein the lens is a biconic lens, the biconic lens has a first surface and a second surface opposite to the first surface, the curvatures of the first surface in the first axis and in the second axis are unequal to each other and the curvatures of the second surface in the first axis and in the second axis are unequal to each other.

12. The projection apparatus as recited in claim 9, wherein the lens is a cylindrical lens and one of the curvatures of the first surface of the cylindrical lens in the first axis and in the second axis is equal to zero.

13. The projection apparatus as recited in claim 9, wherein the lens comprises a Fresnel lens.

14. The projection apparatus as recited in claim 9, wherein the point light source array comprises:
a substrate; and
multiple point light sources, arranged in an array on the substrate.

15. The projection apparatus as recited in claim 14, wherein the point light sources comprise light emitting diodes or laser light sources.

16. The projection apparatus as recited in claim 14, wherein the point light sources possess at least a color.

17. The projection apparatus as recited in claim 14, wherein the point light sources are arranged on the substrate in an N×M array, and N≠M, and N and M are positive integers.
